(19) United States
(12) Patent Application Publication
(10) Pub. No.: US 2025/0024875 A1
(43) Pub. Date: Jan. 23, 2025

(54) SANDWICH-STUFFING FOOD FORMING APPARATUS

(71) Applicant: ANKO FOOD MACHINE CO., LTD., New Taipei City (TW)

(72) Inventor: JUI FENG CHU, New Taipei City (TW)

(21) Appl. No.: 18/238,515

(22) Filed: Aug. 27, 2023

(30) Foreign Application Priority Data
Jul. 19, 2023 (TW) 112207544

(51) Int. Cl. A23P 20/20; A23P 30/20

(52) U.S. Cl. CPC A23P 20/20; A23P 30/20

(57) ABSTRACT

Provided is a sandwich-stuffing food forming apparatus, which uses differential speed rollers to avoid the problem that the wrapper cannot be aligned after the folding action in the prior art (the stuffing cannot be completely wrapped inside the wrapper). Further using conveyor belts with different speeds to increase the yield and aligner to solve the positioning problem of the sandwich-stuffing food during the production process (due to differences in conveyor belt speeds and/or heights), to solve technical problems encountered in the automation of sandwich-stuffing food.

### FIELD OF THE INVENTION

The present invention relates to a sandwich-stuffing food forming apparatus, and more particularly, applied in food processing machinery, to solve the technical problem of shaping during the sandwich-stuffing food forming process.

### BACKGROUND OF THE INVENTION

In the prior art, for the forming apparatus of Mexican pie (Quesadilla) type food, generally, a whole pack of Quesadilla generally comprises stuffing sandwiched between two tortillas, or a slice of tortilla folded as a half-circle (stuffing is in the middle). In case that the stuffing is sandwiched between two slices of tortillas, it will be cut to expose the stuffing to the customer. For the half-circle Quesadilla, because a folding action is implemented during the preparing process, the sides of the wrapper (tortilla) are often not aligned after being folded, resulting in exposure of part of the stuffing. The Quesadilla are presented in a sandwich-like appearance, the customers can see the stuffing. However, it is necessary to avoid that the stuffings will be exposed and fall due to the misalignment of the two sides of the wrapper during the automatic production process.

Thus, there is a need to provide a sandwich-stuffing food forming apparatus to solve the foregoing technical issue of the prior art.

### SUMMARY OF INVENTION

For solving the foregoing technical issue of the prior art, the present invention uses differential speed rollers to avoid the problem that the wrapper cannot be aligned after the folding action in the prior art (the stuffing cannot be completely wrapped inside the wrapper). Further using conveyor belts with different speeds to increase the yield and aligner to solve the positioning problem of the sandwich-stuffing food during the production process (due to differences in conveyor belt speeds and/or heights), to solve technical problems encountered in the automation of sandwich-stuffing food.

An objective of the present invention is to provide a sandwich-stuffing food forming apparatus, comprising a first operating area and a second operating area. The first operating area comprises: a wrapper receiving area, a first conveyor belt, a stuffing feeder and a folder. The wrapper receiving area is employed for receiving a wrapper. The first conveyor belt transports the wrapper in a first direction. The stuffing feeder is employed to extrude a stuffing onto the wrapper when the first conveyor belt transports the wrapper to the stuffing feeder. The folder is employed to fold the wrapper toward the stuffing along a direction perpendicular to the first direction to form a semi-finished product, when the first conveyor belt transports the wrapper to the folder. The wrapper of the semi-finished product is C-shaped to wrap the stuffing in the middle of the wrapper. The second operating area comprises at least one differential roller. The at least one differential roller contacts an upper part of the wrapper on the stuffing when the semi-finished product is transported to the at least one differential roller. The first conveyor belt transports the semi-finished product from the first operating area to the second operating area.

In a preferred embodiment, the second operating area further comprises a second conveyor belt, employed to transport the semi-finished product.

In a preferred embodiment, a tangential speed at a position where the at least one differential roller contacts the semi-finished product is not equal to a speed of the second conveyor belt.

In a preferred embodiment, a tangential speed at a position where the at least one differential roller contacts the semi-finished product is smaller than a speed of the second conveyor belt.

In a preferred embodiment, a direction of a tangential speed at a position where the at least one differential roller contacts the semi-finished product is different from a direction of a speed of the second conveyor belt.

In a preferred embodiment, a ratio of a tangential speed at a position where the at least one differential roller contacts the semi-finished product and a speed of the second conveyor belt is between 1.02 and 1.35.

In a preferred embodiment, the first conveyor belt operates intermittently, and the second conveyor belt operates continuously.

In a preferred embodiment, a speed of the first conveyor belt is greater than a speed of the second conveyor belt.

In a preferred embodiment, a ratio of a speed of the first conveyor belt and a speed of the second conveyor belt is between 1.05 and 1.1.

In a preferred embodiment, the second operating area further comprises an aligner, located before the at least one differential roller, and a closest distance between the aligner and the second conveyor belt is smaller than a thickness of the semi-finished product in a second direction perpendicular to the first direction.

In a preferred embodiment, the aligner periodically moves up and down in the second direction perpendicular to the first direction, and the aligner stays at the closest distance for a specified time.

Compared with the prior art, the present invention uses differential speed rollers to avoid the problem that the wrapper cannot be aligned after the folding action in the prior art (the stuffing cannot be completely wrapped inside the wrapper). Further using conveyor belts with different speeds to increase the yield and aligner to solve the positioning problem of the sandwich-stuffing food during the production process (due to differences in conveyor belt speeds and/or heights), to solve technical problems encountered in the automation of sandwich-stuffing food.

### BRIEF DESCRIPTION OF THE ACCOMPANYING DRAWINGS

FIG. 1 depicts a diagram of an entire machine comprising a sandwich-stuffing food forming apparatus according to the present invention;

FIG. 2 depicts a diagram of the wrapper receiving area shown in FIG. 1;

FIG. 3A to FIG. 3B depict diagrams of the stuffing feeder shown in FIG. 1;

FIG. 4A to FIG. 4D depict operation diagrams of the folder shown in FIG. 1;

FIG. 5A to FIG. 5B depict operation diagrams of the aligner shown in FIG. 1;

FIG. 6A to FIG. 6C depict operation diagrams of the differential roller shown in FIG. 1; and

FIG. 7 is a parameter table of the sandwich-stuffing food forming apparatus according to the present invention.

### DETAILED DESCRIPTION OF PREFERRED EMBODIMENTS

The following descriptions of the embodiments refer to the appended figures to illustrate specific embodiments in which the present invention may be implemented. The directional terms of up, down, front, rear, left, right, interior, exterior, side, etcetera mentioned in the present invention are merely directions of referring to appended figures. Therefore, the aforesaid directional terms are employed for explaining and understanding the present invention, but the present invention is not limited thereto.

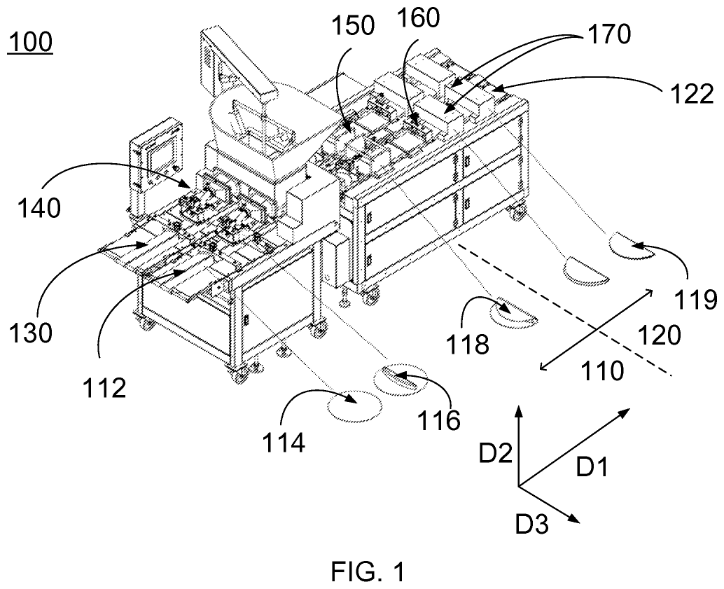

Please refer to FIG. 1, which depicts a diagram of an entire machine comprising a sandwich-stuffing food forming apparatus 100 according to the present invention. The sandwich-stuffing food forming apparatus 100 comprises a first operating area 110 and a second operating area 120. The purpose of dividing into two operating areas here is to maximize the output, and the detailed description will be detailed later. The first operating area 110 comprises: a wrapper receiving area 130, a first conveyor belt 112, a stuffing feeder 140 and a folder 150.

The wrapper receiving area 130 is employed for receiving a wrapper 114. The first conveyor belt 112 transports the wrapper 114 in a first direction D1. The stuffing feeder 140 is employed to extrude a stuffing 116 onto the wrapper 114 when the first conveyor belt 112 transports the wrapper 114 to the stuffing feeder 140. In detail, it can be shown in figure that a stuffing bucket is connected above the stuffing feeder 140.

The folder 150 is employed to fold the wrapper 114 toward the stuffing 116 along a direction perpendicular to the first direction D1 to form a semi-finished product 118, when the first conveyor belt 112 transports the wrapper 114 to the folder 150. From a side view, the wrapper 114 of the semi-finished product 118 is C-shaped to wrap the stuffing 116 in the middle of the wrapper 114. From a top view, the semi-finished product 118 is a half-circle. It can be shown in the figure that the upper side and the lower side of the wrapper 114 of the semi-finished product 118 are not aligned, so that the stuffing 116 will be exposed.

The second operating area 120 comprises two differential rollers 170. After testing, under the operation of the two differential rollers, the upper side and lower side of the semi-finished product 118 can be aligned to prevent the stuffing 116 from being exposed. The two differential rollers 170 contact an upper part of the wrapper 114 on the stuffing 116 when the semi-finished product 118 is transported to the two differential rollers 170. The first conveyor belt 112 transports the semi-finished product 118 from the first operating area 110 to the second operating area 120.

In this preferred embodiment, the second operating area 120 further comprises a second conveyor belt 122. The purpose of this configuration is to allow the first operation area 110 and the second operation area 120 to operate at different speeds. The stuffing feeder 140 requires the wrapper to stay for a certain period of time, so the first conveyor belt 112 operates intermittently; the second operation area 120 has no such requirement, so the second conveyor belt 122 operates continuously. However, because the two differential rollers 170 need to squeeze the wrapper 114 to a certain extent, the speed cannot be too high. In order to optimize the output, in this preferred embodiment, a speed of the first conveyor belt 112 is greater than a speed of the second conveyor belt 122. Preferably, a ratio of the speed of the first conveyor belt 112 and the speed of the second conveyor belt 122 is between 1.05 and 1.1. However, continuous production can be achieved with the configuration that the first conveyor belt 112 operates intermittently. With the speed difference between the differential roller 170 and the second conveyor belt 122, the wrapper 114 is gradually aligned while the wrapper 114 is squeezed, that is, the stuffing 116 is inside the wrapper 114.

Furthermore, the speed of the first conveyor belt 112 and the speed of the second conveyor belt 122 are different. When the semi-finished product 118 enters the second operating area 120 from the first operating area 110, a rotation on the horizontal plane (the plane formed by the first direction D1 and the third direction D3) may occur. Thus, in this preferred embodiment, an aligner 160 is further provided. The aligner 160 is located before the two differential rollers 170. A closest distance between the aligner 160 and the second conveyor belt 122 is smaller than a thickness of the semi-finished product 118 in a second direction D2 perpendicular to the first direction D1. Practically, the aligner 160 is a flat plate in the third direction D3 perpendicular to the first direction D1. Therefore, when the rotated semi-finished product 118 touches the aligner 160, the flat plate makes the straight part of the half-circle semi-finished product 118 appear perpendicular to the first direction D1 for the subsequent operations of the two differential rollers 170.

In detail, the aligner 160 periodically moves up and down in the second direction D2 perpendicular to the first direction D1, and the aligner 160 stays at the closest distance for a specified time.

In detail, a tangential speed at a position where the two differential rollers 170 contact the semi-finished product 118 is not equal to a speed of the second conveyor belt 112. Preferably, the tangential speed is smaller than the speed of the second conveying belt 122 and is towards the opposite direction of the first direction D1.

In this preferred embodiment, for different sizes of round wrappers and corresponding stuffings of different weights, a ratio of the tangential speed at the position and the speed of the second conveyor belt 122 is between 1.02 and 1.35.

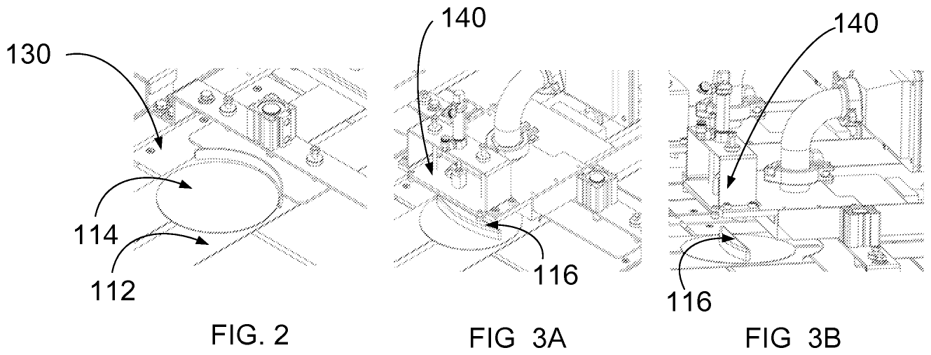

Next, please refer to FIG. 2 to FIG. 7 to describe the workflow of the present invention.

FIG. 2 depicts a diagram of the wrapper receiving area 130 shown in FIG. 1. When the wrapper 114 is circular, it can be shown that the wrapper receiving area 130 possesses an arc-shaped baffle (which will touch the first conveyor belt 112) for positioning, and the shape of the baffle can also be changed according to different shapes. Basically, the present invention takes the wrapper 114 as a circle as the main application object.

FIG. 3A to FIG. 3B depict diagrams of the stuffing feeder 140 shown in FIG. 1. The figures show that the stuffing feeder 140 places the stuffing 116 (segment) matching the circular wrapper 114 on the wrapper 114 from two view angles.

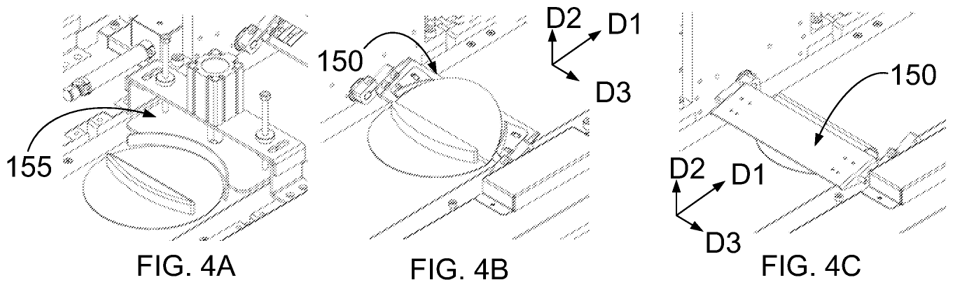

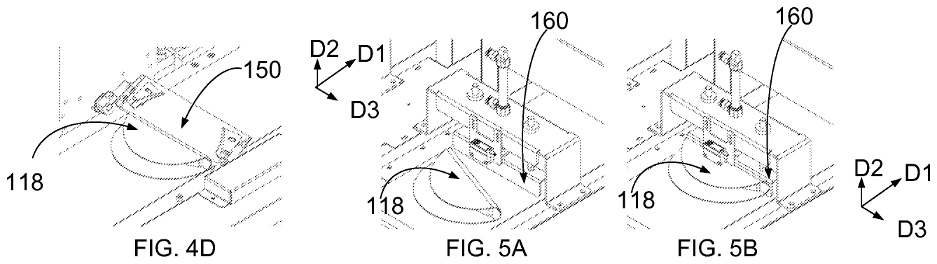

FIG. 4A to FIG. 4D depict operation diagrams of the folder 150 shown in FIG. 1. First, in FIG. 4A, there is a baffle 155 identical to that of FIG. 2 for positioning the wrapper 114 (the stuffing 116 has been placed thereon). In this preferred embodiment, the folder 150 is a plate that can be folded in the direction opposite to the first direction D1. In FIG. 4B, when the front half of the wrapper 114 is transported to the folder 150 by the first conveyor belt 112, the folder 150 rotates to drive the front half of the wrapper 114 to cover the rear half of the wrapper 114, as shown in FIG. 4C. Finally, the semi-finished product 118 is formed as shown in FIG. 4D. The wrapper 114 of the semi-finished product 118 is C-shaped to wrap the stuffing 116 in the middle of the wrapper 114.

FIG. 5A to FIG. 5B depict operation diagrams of the aligner 160 shown in FIG. 1. As shown in figures, the aligner 160 is a sheet-shaped baffle that moves up and down in the second direction D2. The direction of the sheet-shaped baffle is in the third direction D3 perpendicular to the first direction D1 and the second direction D2. Therefore, with the state that the distance between the sheet-shaped baffle and the second conveyor belt 122 is smaller than the thickness of the semi-finished product 118, if the semi-finished product 118 is rotated as shown in FIG. 5A, the semi-finished product 118 can be aligned as shown in FIG. 5B under the continuous operation of the second conveyor belt 122. Accordingly, it can be convenient for the subsequent differential rollers 170 to perform extrusion and shaping, and to align the upper side and lower side of the wrapper 114 at the same time.

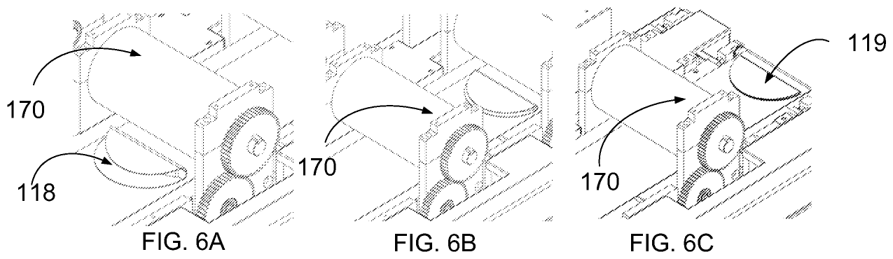

FIG. 6A to FIG. 6C depict operation diagrams of the differential roller 170 shown in FIG. 1. It can be known that after the first differential roller 170 (near the aligner 160), the distance between the upper side and lower of the semi-finished product 118 is shortened; After the second differential roller 170 (away from the aligner 160), the upper side and lower side of the semi-finished product 118 can be aligned to form a finished product 119. In this preferred embodiment, the rotation speeds of the differential rollers and the distance from the second conveyor belt 122 can be adjusted according to the size of the wrapper 112 and the weight of the stuffing 116. As shown in FIG. 6B, the upper side and the lower side of the wrapper 114 of the semi-finished product 118 are approximately aligned; as shown in FIG. 6C, the upper side and the lower side of the wrapper 114 of the semi-finished product 118 are completely aligned to prevent the stuffing 116 from being exposed.

In detail, the distance between the differential roller 170 near the aligner 160 and the second conveyor belt 122 is greater than the distance between the differential roller 170 away from the aligner 160 and the second conveyor belt 122. Certainly, there is no limit to using more differential rollers to achieve better results.

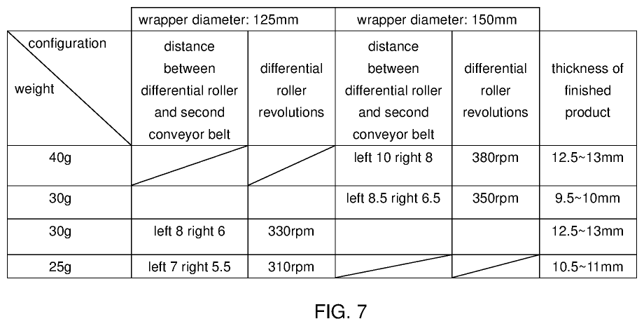

Please refer to FIG. 7, which is a parameter table of the sandwich-stuffing food forming apparatus according to the present invention. The weight on the upper left refers to the weight of the stuffing 116. For example, when the wrapper 114 is a 125 mm circular shape and the stuffing 116 is 30 g, the distance between the first differential roller 170 (near the aligner 160) and the second conveyor belt 122 is 8 mm; the distance between the second differential roller 170 (away from the aligner 160) and the second conveyor belt 122 is 6 mm, and the finished product 119 formed will possess a thickness of 12.5 mm to 13 mm.

Compared with the prior art, the present invention uses differential speed rollers to avoid the problem that the wrapper cannot be aligned after the folding action in the prior art (the stuffing cannot be completely wrapped inside the wrapper). Further using conveyor belts with different speeds to increase the yield and aligner to solve the positioning problem of the sandwich-stuffing food during the production process (due to differences in conveyor belt speeds and/or heights), to solve technical problems encountered in the automation of sandwich-stuffing food.

Above are only preferred embodiments of the present invention, and it should be noted that to any persons who are skilled in the art, improvement and modification which is easily derived should be covered by the protected scope of the application. Thus, the protected scope of the application should go by the subject claims, including the improvement and the modification.

What is claimed is:

1. A sandwich-stuffing food forming apparatus, comprising:
a first operating area, comprising:
a wrapper receiving area, receiving a wrapper;
a first conveyor belt, transporting the wrapper in a first direction;
a stuffing feeder, employed to extrude a stuffing onto the wrapper when the first conveyor belt transports the wrapper to the stuffing feeder;
a folder, employed to fold the wrapper toward the stuffing along a direction perpendicular to the first direction to form a semi-finished product, when the first conveyor belt transports the wrapper to the folder and the wrapper of the semi-finished product is C-shaped to wrap the stuffing in the middle of the wrapper; and
a second operating area, comprising:
at least one differential roller, contacting an upper part of the wrapper on the stuffing when the semi-finished product is transported to the at least one differential roller;
wherein the first conveyor belt transports the semi-finished product from the first operating area to the second operating area.

2. The sandwich-stuffing food forming apparatus according to claim 1, wherein the second operating area further comprises a second conveyor belt, employed to transport the semi-finished product.

3. The sandwich-stuffing food forming apparatus according to claim 2, wherein a tangential speed at a position where the at least one differential roller contacts the semi-finished product is not equal to a speed of the second conveyor belt.

4. The sandwich-stuffing food forming apparatus according to claim 2, wherein a tangential speed at a position where the at least one differential roller contacts the semi-finished product is smaller than a speed of the second conveyor belt.

5. The sandwich-stuffing food forming apparatus according to claim 2, wherein a direction of a tangential speed at a position where the at least one differential roller contacts the semi-finished product is different from a direction of a speed of the second conveyor belt.

6. The sandwich-stuffing food forming apparatus according to claim 2, wherein a ratio of a tangential speed at a position where the at least one differential roller contacts the semi-finished product and a speed of the second conveyor belt is between 1.02 and 1.35.

7. The sandwich-stuffing food forming apparatus according to claim 2, wherein the first conveyor belt operates intermittently, and the second conveyor belt operates continuously.

8. The sandwich-stuffing food forming apparatus according to claim 2, wherein a speed of the first conveyor belt is greater than a speed of the second conveyor belt.

9. The sandwich-stuffing food forming apparatus according to claim 2, wherein a ratio of a speed of the first conveyor belt and a speed of the second conveyor belt is between 1.05 and 1.1.

10. The sandwich-stuffing food forming apparatus according to claim 2, wherein the second operating area further comprises an aligner, located before the at least one differential roller, and a closest distance between the aligner and the second conveyor belt is smaller than a thickness of the semi-finished product in a second direction perpendicular to the first direction.

11. The sandwich-stuffing food forming apparatus according to claim 10, wherein the aligner periodically moves up and down in the second direction perpendicular to the first direction, and the aligner stays at the closest distance for a specified time.
